(19) United States
(12) Patent Application Publication
(10) Pub. No.: US 2008/0256816 A1
(43) Pub. Date: Oct. 23, 2008

(54) MULTI-TOOL UNIT

(75) Inventor: Bruno Cosentino, Croton-on-Hudson, NY (US)

Correspondence Address: COLLEN IP, THE HOLYOKE MANHATTAN BUILDING, 80 SOUTH HIGHLAND AVENUE, OSSINING, NY, 10562, US

(73) Assignee: Peter Croese, Croton-on-Hudson, NY (US)

(21) Appl. No.: 11/738,049

(22) Filed: Apr. 20, 2007

(51) Int. Cl. G01B 3/10

(52) U.S. Cl. 33/760

(57) ABSTRACT

A multi-use tool designed to be easily handled and transported. The two main compartments include a utility knife and a tape measure. Numerous other tools can be included in this device including hammer, level, screwdriver, saw, file and wrench.

### BACKGROUND

Many forms of multi-use/multi-function tool and tool carrying devices exist. These include tool bags, tool belts and tool boxes along with screwdrivers with multiple tips; single unit tools with screwdrivers, knives, scissors, and files. Most multi-use tools are designed around pliers. None of the existing prior art includes a replaceable blade utility knife along with a tape measure in a single hand compatible unit.

### SUMMARY OF INVENTION

This invention involves a new innovative compact tool unit including a utility knife and a tape measure. Numerous other tools such as hammer, square, level, writing surface, screwdriver(s), saw blade(s), file, and pry hook can be included.

### BRIEF DESCRIPTION OF DRAWINGS

FIG. 1 is a sectional 1-1 view from the back of the multiple tool unit.

FIG. 2 is a front view of the multiple tool unit.

FIG. 3 is a rear view of the multiple tool unit with some tools extended.

FIG. 4 is a sectional view 2-2 of the multiple unit.

FIG. 5 is a top view of the multiple tool unit.

FIG. 6 is a bottom view of the multiple tool unit.

FIG. 7 is a top view of the multiple tool unit with hinged compartment open.

FIG. 8 is a view of the sub-compartment.

FIG. 9 is a rear perspective view of the lower portion of the tape compartment and a blow-up view of degree markings.

FIG. 10 is a front view of the retractable knife blade carriage

FIG. 11 is a rear view of the retractable knife blade carriage.

FIG. 12 is a view of the multiple tool unit used as an inside square.

FIG. 13 is a view of the multiple tool unit used as an outside square.

FIG. 14 is a view of the multiple tool unit used to determine angles.

FIG. 15 is a view of the multiple tool unit with the v-shaped wrench extended.

### PART NUMBERS GUIDE

1. Multiple tool unit

2. Knife compartment

3. Tape compartment

4. Blade carriage

5. Blade carriage track

6. Blade stop button

7. Knife access door hinge

8. Compartment divider

9. Pencil holder

10. Writable surface

11. Blade slide adjustor

12. Knife compartment latch

13. Tape spindle

14. Tape measure

15. Tape measure brake

16. Sub-compartment

17. Sub-compartment pin

18. Carbine saw

19. Flat head screwdriver

20. Philips head screwdriver

21. Multipurpose saw

22. Steel rule

23. Pencil sharpener

24. Pencil shavings chute

25. Hammer head(s)

26. Bubble vials

27. Scrapers

28. Pry hook

29. Belt Clip

30. Screws

31. Angle markings

32. Square corner

33. File

34. Knife resistance spring

35. Knife carriage notches

36. Blade Slide button

37. Wrench

38. Glass tile scoring wheel

### DETAILED DESCRIPTION OF THE PREFERRED EMBODIMENT

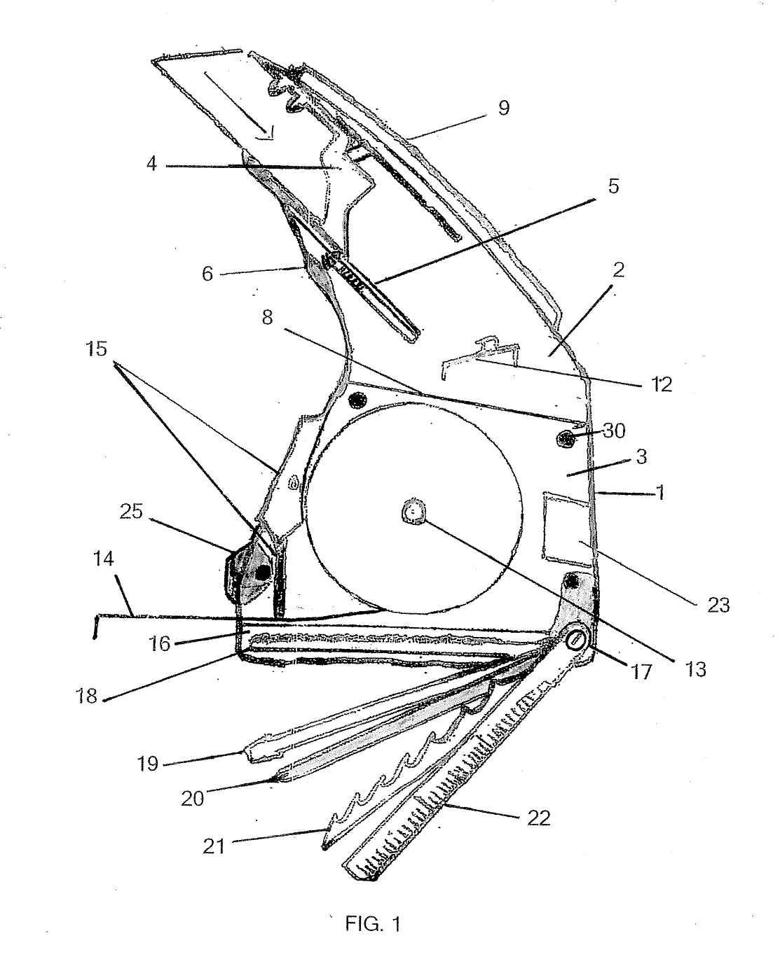

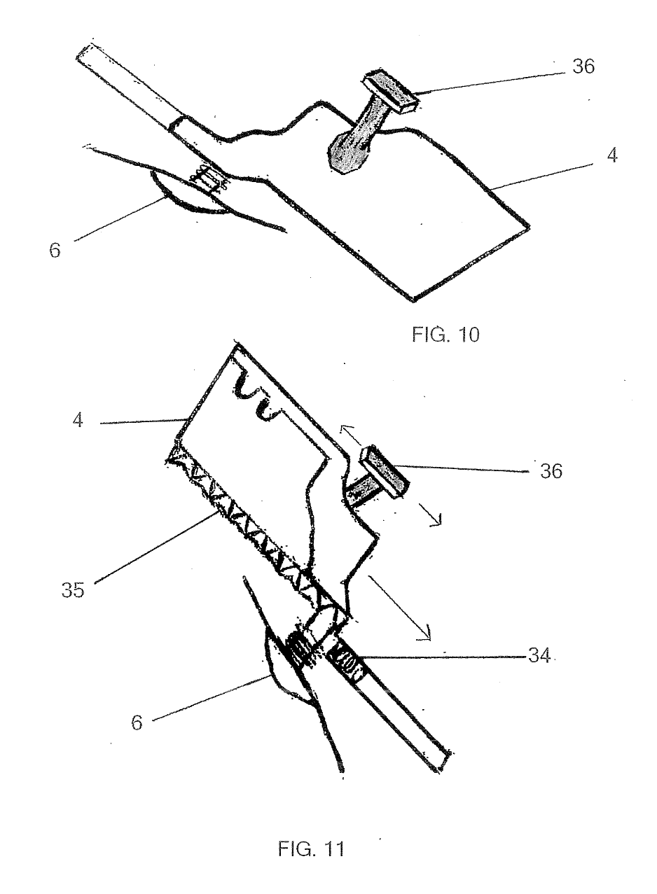

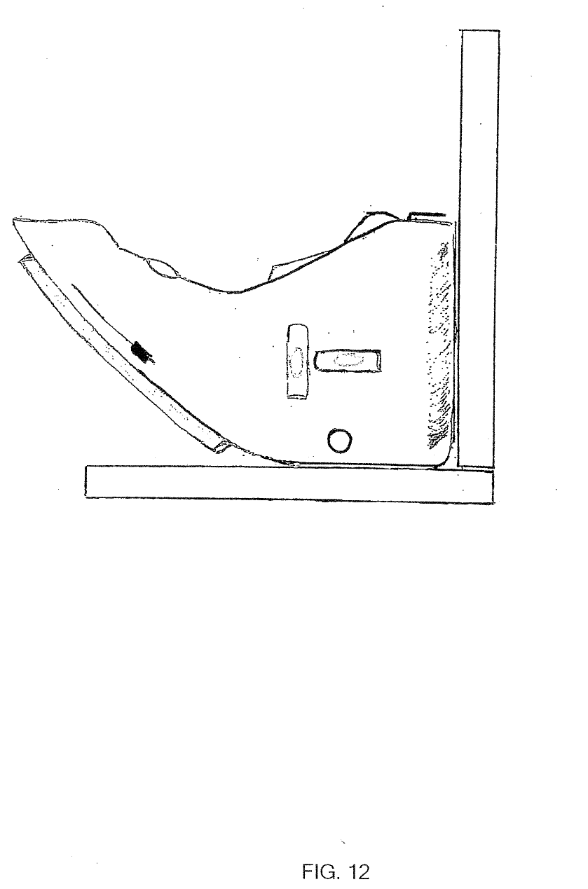

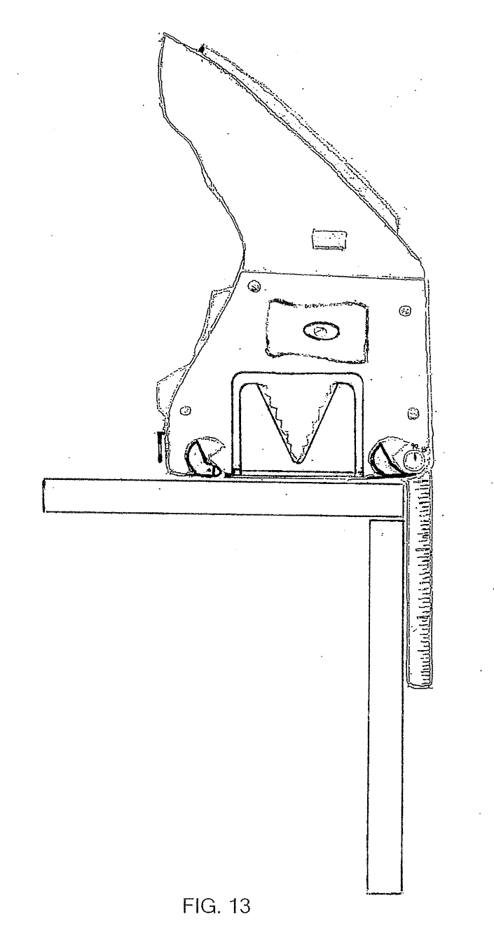

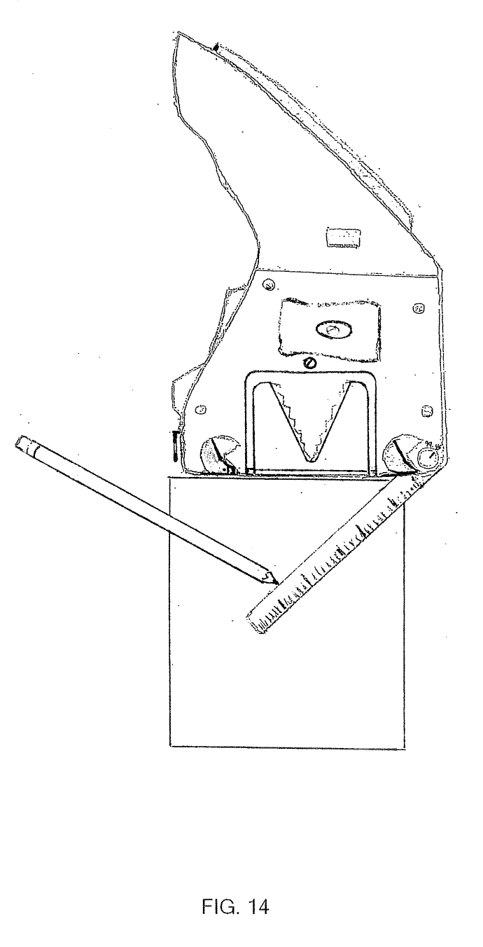

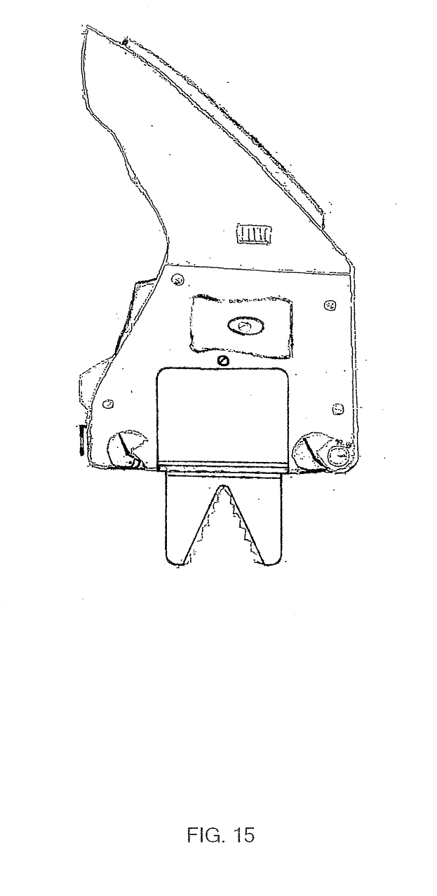

As depicted on FIG. 1, this multiple tool unit (1) includes a housing with two main compartments (2 and 3). The entire unit (1) is designed to be easily held in hand. These two compartments are the knife compartment (2) and the tape measure compartment (3). The knife compartment can incorporate features from a typical retractable knife readily available with a blade carriage (4), a blade carriage track (5), and a blade stop button (6). The retractable knife in this invention also includes additional features to increase safety associated with its use by including the automatic return of the blade to inside the knife compartment. As shown on FIGS. 10 and 11, the knife assembly in this invention also includes a resistance spring (34), notches on blade carriage (35), a spring loaded blade stop button (6) which engages one of the notches on the carriage (35), a blade slide button (36) which is accessible externally to knife compartment (2), and a blade carriage (4) which is magnetized to better hold the blade.

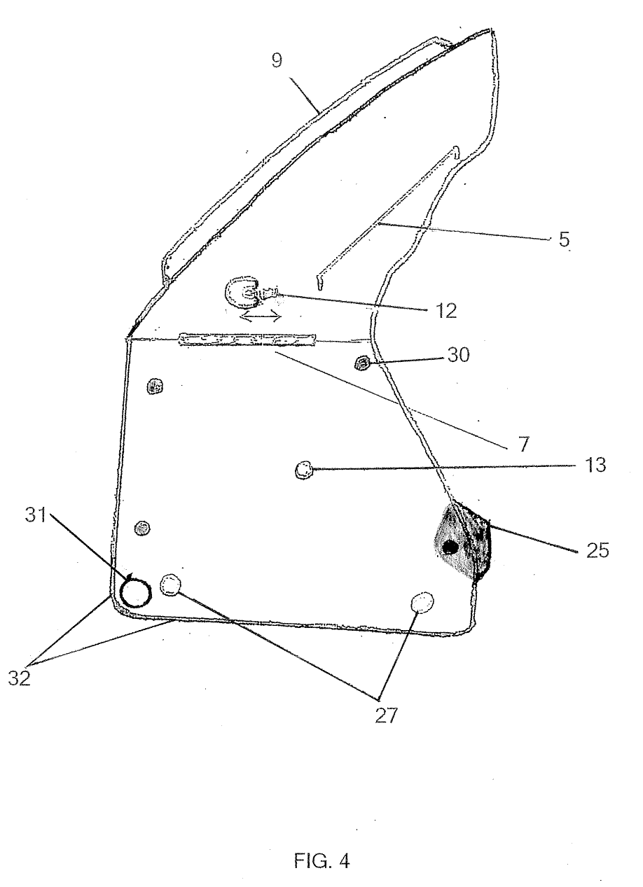

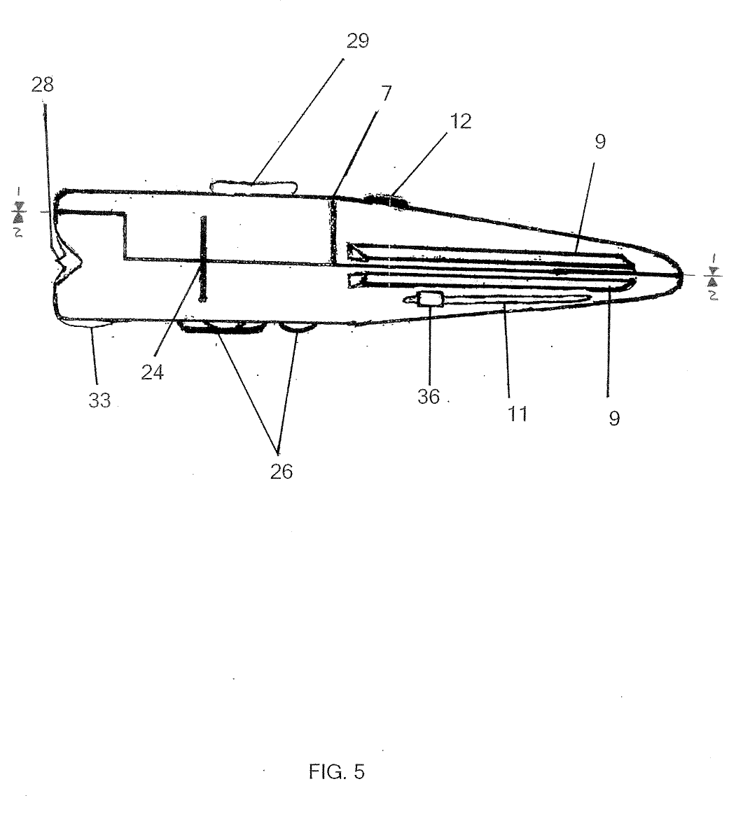

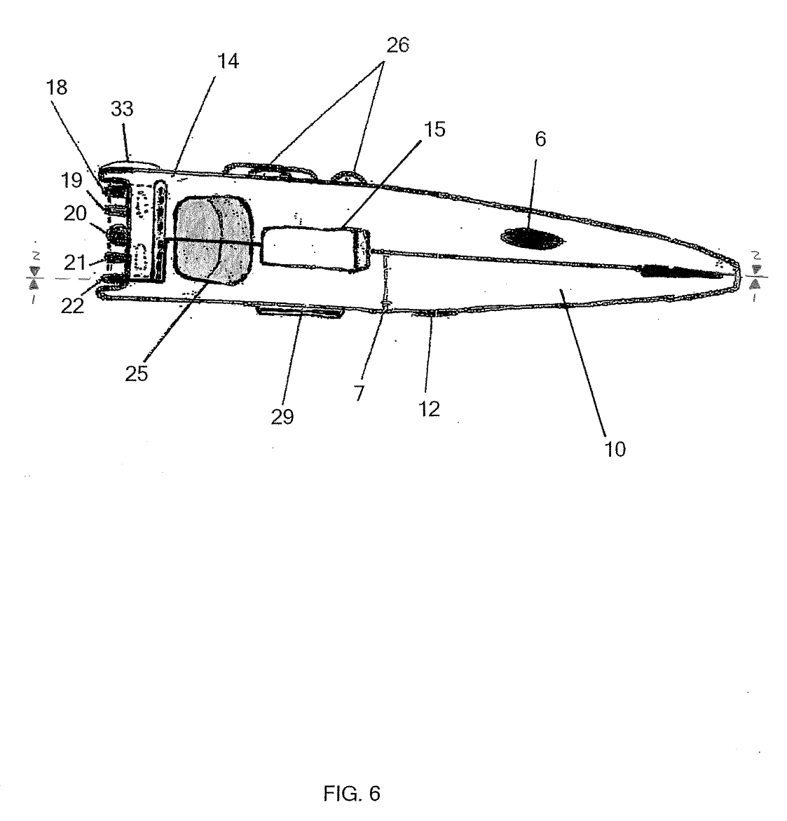

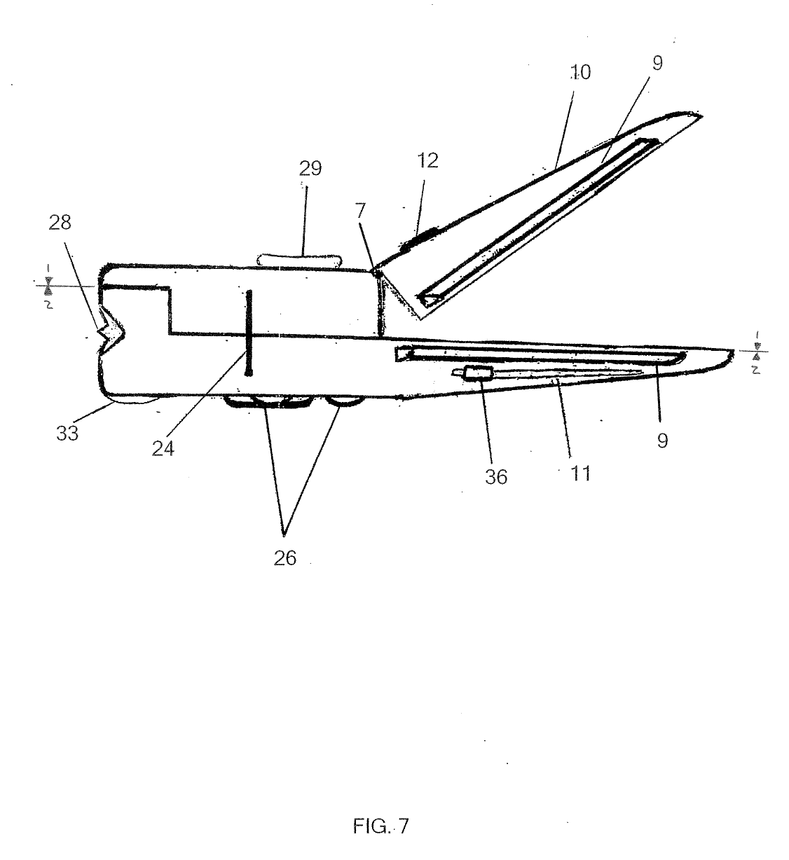

This invention further includes a means to access the knife compartment (3) as depicted in FIG. 4 via a hinge (7) or as a removable panel (not shown) A latch (12) is provided to allow a means to secure and open the panel which is attached via a hinge (7) to the tape measure compartment(3). The latch can include a spring (not shown) to maintain pressure on the door latch when closed and springing the door open when unlatched. The knife compartment is also designed with space for storing extra or used blades and can include a magnetic compartment divider (8) to hold the blades.

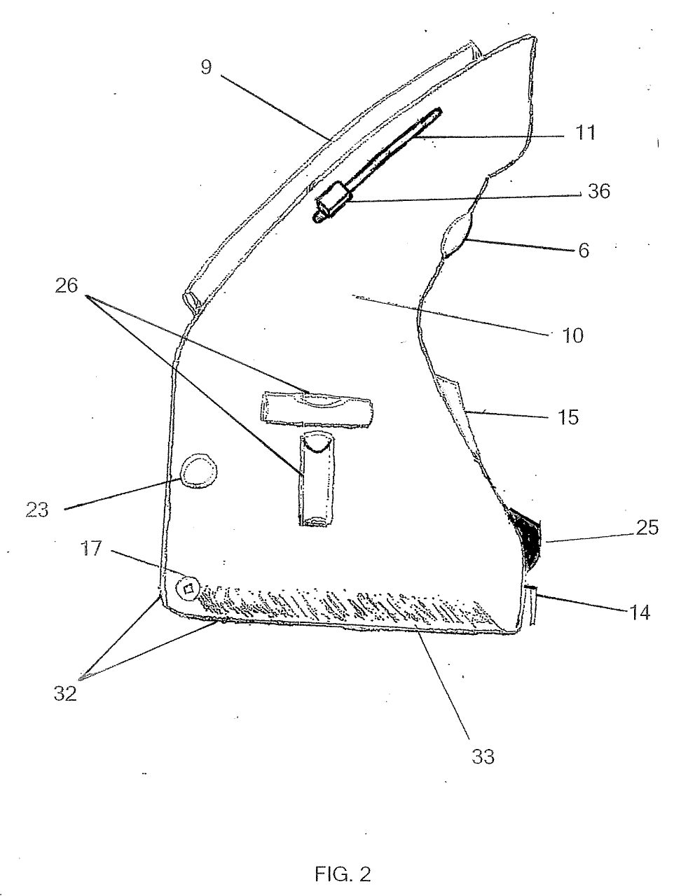

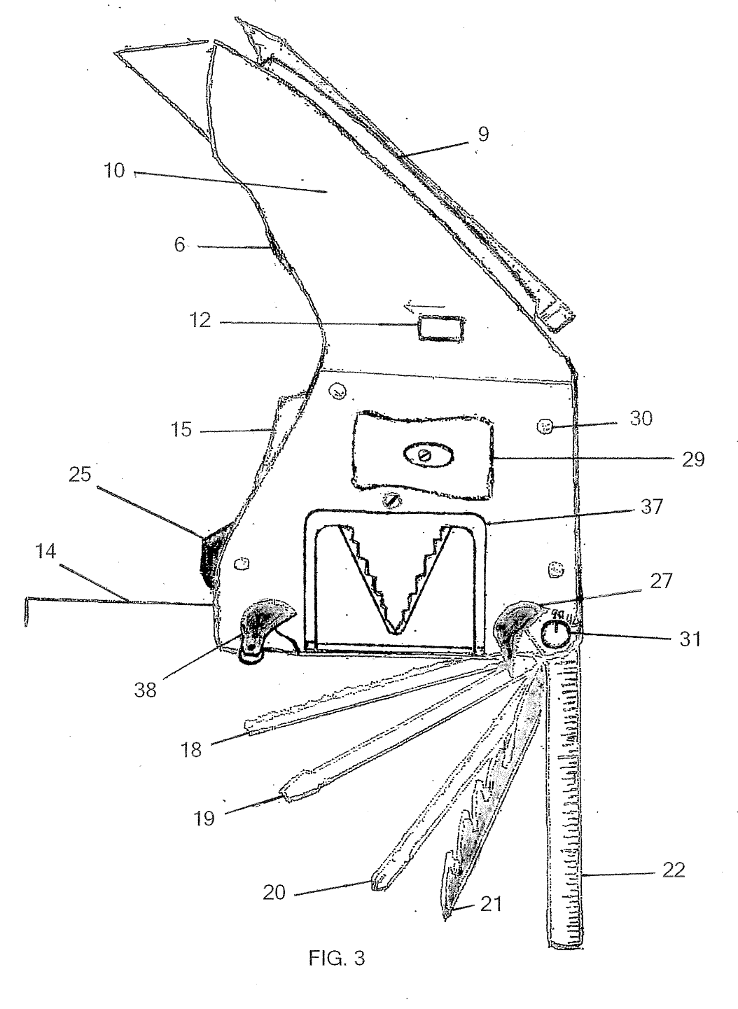

The knife compartment can also include a pencil holder (9), a surface allowing writing and erasing (10), and a blade slide adjustor (11) as depicted on FIG. 2.

The tape measure compartment (3) is designed to incorporate numerous tools in addition to a retractable spring loaded tape measure. As depicted on FIG. 1, the compartment (3) includes a tape spindle (13), a tape measure (14) and a brake (15). A sub-compartment (16) can be created on the bottom of compartment 2 to house various tools which can pivot around a pin (17) as required to allow their use. The tools in the sub-compartment (16) can include tools such as a carbine saw (18), flat head screwdriver (19), Phillips head screwdriver (20), multipurpose saw (21), and steel rule (22). Depending on the intended user, other tools (such as pliers, scissors, wrenches, flashlight etc.) can be substituted for these or added to these.

In addition such tools could be designed to be totally removable (i.e., no pin or removable from pin) from the sub-compartment (16) if desired.

Other tools which can be included in the design for the tape measure compartment (3) include: pencil sharpener (23) and associated shavings chute (24); hammer with two heads (25); bubble vials (26) for determining degree of plumb and level; pivoting scrapers (27) for scoring surfaces, removing grout, etc; pry hook (28); a belt clip (29), a multipurpose file (33), and a V-shaped wrench (37) on outer surface of compartment that flips out for use.

In another embodiment of this invention, a lamp is provided powered by battery (ies) located in the top compartment. The lamp can further be designed to swivel to point light where it is needed.

This multiple tool unit (1) is designed to be modified to suit an intended user. Thus one or both of the scrapers can be replaced with a glass/tile scoring wheel (38). Individual tools, in sub-compartment (16) can be replaced as desired. The entire multi-tool unit in sub-compartment (16) can be replaced by an entire new multiple tool sub-compartment unit as desired for a particular job.

The tape measure compartment as depicted in the drawings is designed with a removable panel/cover to access the compartment if needed. Screws (30) are one shown on the Figures to facilitate such access. The tape measure compartment can also be designed to allow writing and erasing by the user.

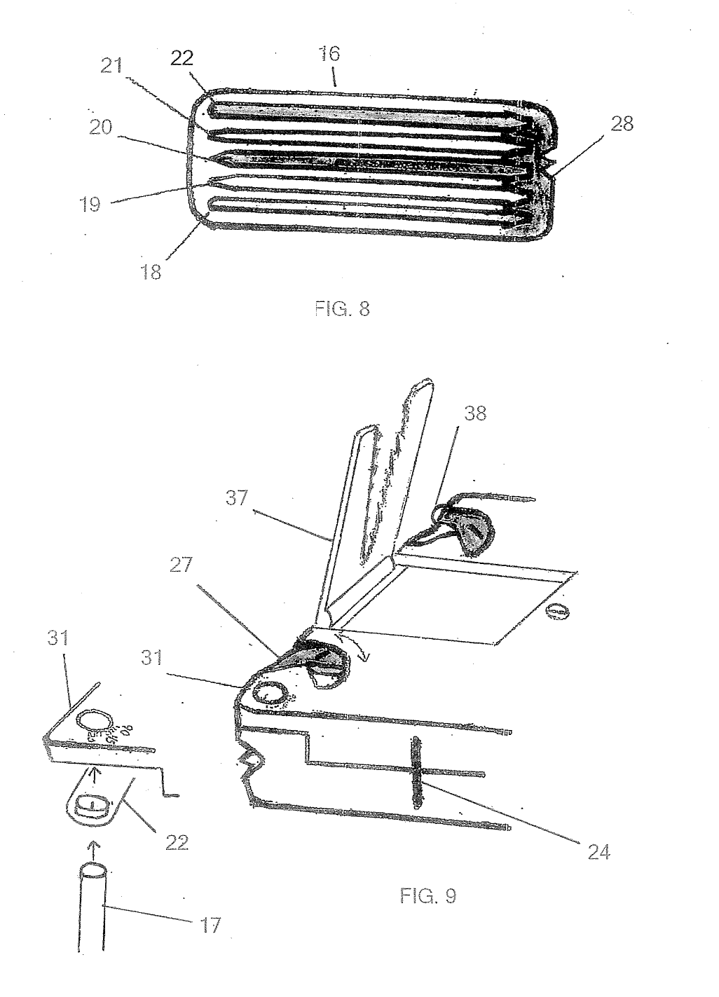

FIG. 9 further depicts a means to determine the angle between two surfaces by including a marker on a pivoting tool which is visible through an opening to point to the angle indicated on markings (31) on the outside cover of the compartment. To facilitate this as well as for accurate use of the bubble vials (26) for determining plumb and level, the tape measure compartment (3) is designed with at least one corner (32) being square.

The entire multiple-tool unit a compact unit designed for easy comfortable hand use.

The above description and accompanying Figures are examples of the present invention. The scope of the present invention is not limited by the exemplary embodiment. Other applications and variations of the present inventions will be obvious to a person skilled in the art. For example in lieu of the extendable V-shaped wrench, a magnifying glass, straight razor or small storage case could be included. The multiple-tool unit could also be designed to allow swapping one of these tools for another by including easy means for removal and replacement.

I claim:

1. A multiple tool unit comprising:
a retractable tape measure;
a compartment housing the tape measure;
a retractable knife;
a compartment housing the retractable knife;
a housing including both the tape measure compartment and the knife compartment;
additional tools included in a minimum of one of the two compartments; and
access provided to all tools in each compartment.

2. A multiple tool unit according to claim 1 wherein the knife compartment further comprises: a pencil holder and a knife blade storage space.

3. A multiple tool unit according to claim 2 further comprising the outer surface of at least one compartment designed to allow writing to be added and erased from it.

4. A multiple tool unit according to claim 1 wherein a panel covering the knife compartment is attached to the divider between the two compartments via a hinge.

5. A multiple tool unit according to claim 4 wherein the retractable knife comprises:
a blade carriage;
a blade slide button;
a blade carriage track, and
a blade stop button.

6. A multiple tool unit according to claim 5 further comprising:
a resistance spring;
a notched blade carriage; and
a spring loaded blade stop button designed to engage the notched blade carriage.

7. A multiple tool unit according to claim 1 in which the tape measure compartment includes a spring loaded tape spindle and a break for the tape measure.

8. A multiple tool unit according to claim 7 further comprising a V-shaped wrench on an outer surface of the tape measurement compartment and designed to be flipped away from the compartment for use.

9. A multiple tool unit according to claim 7 further comprising:
a sub-compartment;
a minimum of two additional tools secured near one end of the sub-compartment to a pin mounted in the sub-compartment; and
an opening to allow the tools to be pivoted out of the sub-compartment.

10. A multiple tool unit according to claim 9 in which the additional tools are individually stored and removable in lieu of pivoting.

11. A multiple tool unit according to claim 9 in which the additional tools are chosen from the following groups of tools:
screwdrivers;
saw blades;
pliers;
wrenches;
flashlights;
files; and
scaled measurement rules.

12. A multiple tool unit according to claim 7 in which a minimum of one corner of the tape measure compartment is square.

13. A multiple tool unit according to claim 12 further comprising a minimum of three tools chosen from:
a hammer head;
a lamp
a bubble vial mounted to detect if an object is level;
a scrapper;
a pry hook;
a pencil sharpener; and
a multipurpose file.

14. A multiple tool unit according to claim 13 in which a glass/tile scoring wheel is included.

15. A multiple tool unit according to claim 9 in which a mark on a pivoting tool is visible through an opening in the tape measure compartment in order to point to angle measurements included on the outer surface of the tape measurement compartment.
